(19) United States
(12) Patent Application Publication
(10) Pub. No.: US 2009/0247295 A1
(43) Pub. Date: Oct. 1, 2009

(54) Network-Based Methods and Apparatus for Rendering Images to an End User

(76) Inventors: Marcus K. Weldon, Summit, NJ (US); Christopher A. White, Neshanic Station, NJ (US)

Correspondence Address: Ryan, Mason & Lewis, LLP, Suite 205, 1300 Post Road, Fairfield, CT, 06824, US

(21) Appl. No.: 12/058,932

(22) Filed: Mar. 31, 2008

(51) Int. Cl. A63F 13/00

(52) U.S. Cl. 463/31

(57) ABSTRACT

Network-based methods and apparatus are provided for rendering images to an end user. Video images are generated by receiving user input from a remote user; rendering the video in real-time in response to the user input; and transmitting the video to the user. The video may comprise, for example, video game images and the video game is executed by a centralized tendering engine. The rendering can be performed by a rendering engine that is remote from the user. The user input can be obtained, for example, from one or more of a game pad, steering wheel and joystick that is local to the user. A service provider can transmit the video to the user using a pre-existing media distribution connection between the service provider and the user

### FIELD OF THE INVENTION

The present invention relates to the rendering of images, such as video games, and, more particularly, to methods and apparatus for network-based rendering of such images to an end user.

### BACKGROUND OF THE INVENTION

Video games are typically executed by equipment located within the home of the end-user, such as a general-purpose computer or a special-purpose game console, such as Xbox, commercially available from Microsoft Corp., Playstation 3, commercially available from Sony Corporation of America, and Wii, commercially available from Nintendo of America, Inc. Generally, the computer or game console accepts input from a user and lenders the video images to a suitable display device. A console thus contains both the hardware for rendering images locally and the software for executing the desired game. Special-purpose video game consoles are becoming increasingly expensive, for example, due to the ever increasing hardware requirements of modern video games.

The above-described game configuration requires that both the appropriate hardware and software are present in the user's home. This makes hardware updates, software distribution, and software license management difficult. A need therefore exists for a video game system configuration that leverages existing network connectivity and eliminates the need for expensive special-purpose game consoles in each home. A further need exists for a video game system configuration that moves the gaming equipment into the network so that it can be shared by a number of users. Yet another need exists for a video game system configuration that allows for centralized distribution, maintenance and licensing management.

### SUMMARY OF THE INVENTION

Generally, network-based methods and apparatus are provided for rendering images to an end user. According to one aspect of the invention, video images are generated by receiving user input from a remote user; rendering the video in real-time in response to the user input; and transmitting the video to the user. The video may comprise, for example, video game images and the video game is executed by a centralized tendering engine. The rendering can be performed by a rendering engine that is remote from the user. The user input can be obtained, for example, from one or more of a game pad, steering wheel and joystick that is local to the user.

The present invention can be provided, for example, by a service provider and the video is transmitted to the user using a pre-existing media distribution connection between the service provider and the user. According to another aspect of the invention, audio can also be rendered in realtime in response to user input and with the audio being transmitted to the user.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate; and

FIG. 2 illustrates an exemplary game system configuration in accordance with the present invention.

### DETAILED DESCRIPTION

The present invention provides a video game system configuration that leverages existing content distribution network connectivity and eliminates the need for expensive special-purpose game consoles in each home by moving the gaming equipment into the network. In this manner; the centralized game system equipment can be shared by a number of users (thereby allowing greater game variety and/or quality). In addition, the disclosed video game system configuration allows for centralized software distribution, maintenance and licensing management.

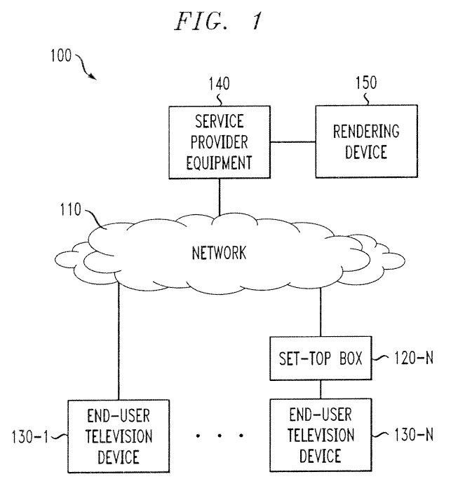

FIG. 1 illustrates an exemplary network environment 100 in which the present invention can operate. As shown in FIG. 1, one or more end-user television devices 130-1 through 130-N (hereinafter, collectively referred to as end-user television devices 130) are connected to a network 110. The network 110 may be embodied, for example, as any wired or wireless network, or a combination thereof; including satellite or cable-based television networks. The network 110 may employ, for example, an Internet Protocol Television (IPTV) standard.

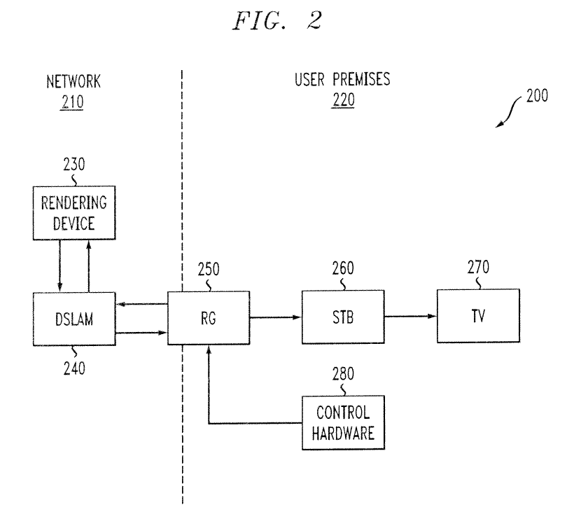

As discussed further below in conjunction with FIG. 2, the end-user television devices 130 may optionally require a set top box 120-N (hereinafter, referred to as set top box 120) to process signals received from service provider equipment 140. The end-user television devices 130 may be embodied as any device capable of presenting video to an end-user, such as a television, portable video device or personal computer.

While the present invention is illustrated herein in the context of an exemplary video game system configuration, the present invention may be applied to any application that requires interactive and centralized computation and rendering with local display or presentation to an end-user. For example, the present invention may also be applied to a three-dimensional rendered “walk through” of a house that is for sale. As used herein, the term tendering shall indicate the real-time (i.e., “on the fly”) creation of a plurality of video frames in response to user input.

In one exemplary embodiment of the present invention, a set top box 120-N within a home of an end-user is employed to display (on a television device 130) video created by a rendering device 150 located within the network 100. Generally, video games are executed in the network 110 on the rendering device 150 with the video being packaged for distribution in a standard video stream and transported on the network 110 in a manner consistent with existing content distribution standards, such as IPTV. The video signals may be based, for example, on the MPEG2 or H 264 video standards. In this manner, no modification is requited to the preexisting content distribution network. The audio and video generated by the rendering device 150 behaves in a fashion substantially identical to a typical television channel or video on demand (VOD) stream.

FIG. 2 illustrates an exemplary game system configuration 200 in accordance with the present invention. As shown in FIG. 2, the exemplary game system configuration 200 comprises a network legion 210 and an end-user premises region 220. The exemplary network region 210 comprises a rendering device 230 and a Digital Subscriber Line Access Multiplexer (DSLAM) 240. Generally, the DSLAM 240 is a network device, typically located near the end-user premises region 220, that connects multiple customer Digital Subscriber Lines (DSLs) to a high-speed Internet backbone line using multiplexing techniques.

According to one aspect of the invention, video games awe executed in the network 210 on the rendering device 230 with the video being packaged for distribution to an end-user in a standard video stream and transported on the network 210 in a manner consistent with existing content distribution standards. The video signals may be based, for example, on the MPEG2 or H 264 video standards. The rendering device 230 may be embodied, for example, as a special-purpose game console, such as Xbox, commercially available from Microsoft Corp., or Playstation 3, commercially available from Sony Corporation of America, or Wii, commercially available from Nintendo of America, Inc., connected to a hardware encoder that encodes the game console output signal within a standard media transport stream for distribution to the end user.

The rendering device 230 will execute the selected game software. The rendering device 230 will stream a sequence of video frames to the end user, for example, encapsulated within an MPEG2 stream. In one implementation, the rendering device 230 can implement an API similar to those provided by personal computer video hardware devices. Games will execute on the rendering device 230 and calls to the API will produce the MPEG2 stream. As discussed below, the set top box (STB) 260 in the user premises 220 will display the MPEG2 stream on the television 270 of the end-user. As previously indicated, the rendering device 230 produces industry standard media streams. Thus, the hardware within the user premises used to view other media streams (such as IPTV, or Video on Demand (VOD)) need not be modified. The game types and communications protocols used can be selected to ensure latency issues do not affect game play.

The exemplary end-user premises region 220 comprises a residential gateway (RG) 250 (e.g., for an Ethernet connection), an optional set-top box 260, a television 270 and control hardware 280. The set top box 260 connects to the television 270 and the DSLAM 240 as the source of the signal. The set top box 260 turns the signal into content that is presented to an end-user on the screen of the television 270. In an IPTV network, for example, the set top box 260 is generally a small computer that provides two-way communications on an IP network, with the primary function of decoding video streaming media. The set top box 260 may be embodied, for example, using the set top boxes commercially available from Scientific-Atlanta or Motorola. It is noted that the functionality of the set top box 260 can be provided in an alternate device, such as a digital video recorder; the television 270 itself or a decoder; such as an MPEG2 decoder.

The control hardware 280 provides a mechanism for user input to indicate movement within the game the control hardware 280 may be embodied, for example, as a game pad, steering wheel or joystick. Upstream signals from the control hardware 280 will be used to drive the game and rendering engine 230. In this manner, the tendering engine 230 will generate a plurality of video frames in real-time in response to the user input. The games and other applications offered by the service provider can be selected, for example, based on the bandwidth available on the back channel from the control hardware 280 to the tendering engine 230.

The tendering hardware 230, game execution, and game software will remain within the network region 210 of a given service provider; and be managed directly by the service provider. In this manner, the service provider provides the same functionality as currently provided by local game consoles, using the existing connectivity to the end-user.

Among other benefits, the centralized game configuration of the present invention allows an end-user to change his or her location for the same game. For example, an instantaneous game status can be transferred to a new location or the output stream from the rendering device 230 can be transferred or rerouted to anew location.

System and Article of Manufacture Details

While exemplary embodiments of the present invention have been described with respect to digital blocks, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definitions information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for generating video, comprising:
receiving user input from a remote user;
rendering said video in real-time in response to said user input; and
transmitting said video to said remote user.

2. The method of claim 1, wherein said video comprises video game images.

3. The method of claim 2, wherein a video game is executed by a centralized rendering engine.

4. The method of claim 1, wherein said method is performed by a service provider and wherein said video is transmitted to said remote user using a pre-existing media distribution connection between said service provider and said remote user.

5. The method of claim 1, wherein said rendering step is performed by a rendering engine that is remote from said remote user.

6. The method of claim 1, wherein said user input is obtained from one or more of a game pad, steering wheel and joystick that is local to said remote user.

7. The method of claim 1, wherein said video is transmitted to a set top box that is local to said remote user.

8. The method of claim 1, wherein said video is transmitted to a television that is local to said remote user.

9. The method of claim 1, further comprising the steps of rendering audio in real-time in response to user input and transmitting said audio to said remote user.

10. A centralized video system, comprising:
a rendering engine having a memory and at least one processor, coupled to the memory, operative to:
receive user input from a remote user;
render said video in real-time using said rendering engine in response to said user input; and
transmit said video to said remote user.

11. The centralized video system of claim 10, wherein said video comprises video game images.

12. The centralized video system of claim 11, wherein a video game is executed by a centralized rendering engine.

13. The centralized video system of claim 10, wherein said centralized video system is provided by a service provider and wherein said video is transmitted to said remote user using a pre-existing media distribution connection between said service provider and said remote user.

14. The centralized video system of claim 10, wherein said rendering is performed by a rendering engine that is remote from said remote user.

15. The centralized video system of claim 10, wherein said user input is obtained from one or more of a game pad, steeling wheel and joystick that is local to said remote user.

16. The centralized video system of claim 10, wherein said video is transmitted to a set top box that is local to said remote user.

17. The centralized video system of claim 10, wherein said video is transmitted to a television that is local to said remote user.

18. The centralized video system of claim 10, wherein said processor is further configured to render audio in realtime in response to user input and transmit said audio to said remote user.

19. An article of manufacture for generating video, comprising a machine readable storage medium containing one or more programs which when executed implement the steps of:
receiving user input from a remote user;
tendering said video in real-time in response to said user input; and
transmitting said video to said remote user.

20. The article of manufacture of claim 19, wherein said rendering step is performed by a rendering engine that is remote from said remote user.
